(19) United States
(12) Patent Application Publication
(10) Pub. No.: US 2023/0368036 A1
(43) Pub. Date: Nov. 16, 2023

(54) PHYSICS-INFORMED MULTIMODAL AUTOENCODER

(71) Applicant: National Technology & Engineering Solutions of Sandia, LLC, Albuquerque, NM (US)

(72) Inventors: Nathaniel Albert Trask, Albuquerque, NM (US); Carianne Martinez, Albuquerque, NM (US); Brad Boyce, Albuquerque, NM (US)

(21) Appl. No.: 17/743,160

(22) Filed: May 12, 2022

(51) Int. Cl. G06N 3/08; G06N 3/04; G06F 30/27

(52) U.S. Cl. CPC G06N 3/088; G06F 30/27; G06N 3/0472

(57) ABSTRACT

Multi-modal data autoencoding is provided. The method comprises receiving a multimodal dataset comprising number of different modalities of data related to a physical phenomenon common to the different modalities of data and encoding each of the different modalities of data into an individual latent representation. The individual latent representations are combined into a single Gaussian mixture distribution in a shared latent space. A number of parallel decoders and physics simulators decode the Gaussian mixture, wherein the decoders and physics simulators respectively reconstruct the multimodal dataset. When a unimodal dataset comprising a single modality of data related to the physical phenomenon is received a value of the physical phenomenon is predicted according to cross-modal inference learning from encoding and decoding of the multimodal dataset.

### GOVERNMENT LICENSE RIGHTS

This invention was made with Government support under Contract No. DE-NA0003525 awarded by the United States Department of Energy/National Nuclear Security Administration. The United States Government has certain rights in this invention.

### BACKGROUND INFORMATION

### 1. Field

The present disclosure relates generally to machine learning. More particularly, illustrative embodiments are directed to a process for encoding and decoding the fusion of high-dimensional data from multiple sources with the option to simultaneously incorporate governing equations alongside the data.

### 2. Background

Scientific and engineering data often consist of multiple heterogeneous sources (multimodal) (e.g., images, 2D data, 1D data, scalar values, time-series data, etc.). For example, in the realm of material manufacturing, processes ranging from microelectronic fabrication to metal additive manufacturing involve a myriad of process settings along with in-process and post-process measurements. Automated high-throughput characterization methods generate large, multimodal datasets fueled by advances in robotics and automation.

Therefore, it would be desirable to have systems, methods and products that take into account at least some of the issues discussed above, as well as other possible issues.

### SUMMARY

An illustrative embodiment provides a computer-implemented method of multi-modal data autoencoding. The method comprises receiving a multimodal dataset comprising number of different modalities of data related to a physical phenomenon common to the different modalities of data and encoding each of the different modalities of data into an individual latent representation. The individual latent representations are combined into a single Gaussian mixture distribution in a shared latent space. A number of parallel decoders and physics simulators decode the Gaussian mixture, wherein the decoders and physics simulators respectively reconstruct the multimodal dataset. When a unimodal dataset comprising a single modality of data related to the physical phenomenon is received a value of the physical phenomenon is predicted according to cross-modal inference learning from encoding and decoding of the multimodal dataset.

Another embodiment provides a system for multi-modal data autoencoding. The system comprises a storage device configured to store program instructions and one or more processors operably connected to the storage device and configured to execute the program instructions to cause the system to: receive a multimodal dataset comprising number of different modalities of data related to a physical phenomenon common to the different modalities of data; encode each of the different modalities of data into an individual latent representation; combine the individual latent representations into a single Gaussian mixture distribution in a shared latent space; decode the Gaussian mixture with a number of parallel decoders and physics simulators, wherein the decoders and physics simulators respectively reconstruct the multimodal dataset; receive a unimodal dataset comprising a single modality of data related to the physical phenomenon; and predict a value of the physical phenomenon according to cross-modal inference learning from encoding and decoding of the multimodal dataset.

Another illustrative embodiment provides a computer program product for multi-modal data autoencoding. The computer program product comprises a computer-readable storage medium having program instructions embodied thereon to perform the steps of: receiving a multimodal dataset comprising number of different modalities of data related to a physical phenomenon common to the different modalities of data; encoding each of the different modalities of data into an individual latent representation; combining the individual latent representations into a single Gaussian mixture distribution in a shared latent space; decoding the Gaussian mixture with a number of parallel decoders and physics simulators, wherein the decoders and physics simulators respectively reconstruct the multimodal dataset; receiving a unimodal dataset comprising a single modality of data related to the physical phenomenon; and predicting a value of the physical phenomenon according to cross-modal inference learning from encoding and decoding of the multimodal dataset.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 depicts a physics-informed multimodal autoencoding (PIMA) system in accordance with an illustrative embodiment;

FIG. 2 depicts a diagram illustrating a node in a neural network in which illustrative embodiments can be implemented;

FIG. 3 depicts a diagram illustrating a neural network in which illustrative embodiments can be implemented;

FIG. 4 depicts a sparse autoencoder neural network in which the illustrative embodiments can be implemented;

FIG. 5 depicts a physics-informed multimodal autoencoder in accordance with an illustrative embodiment;

FIG. 6 depicts images and stress/strain curves comprising multimodal data related to a lattice structure subjected to external mechanical loading in accordance with an illustrative embodiment;

FIG. 7 depicts a graph showing different clusters of data points corresponding to different levels of stress and strain and associated levels of deformation of the microstructure in accordance with an illustrative embodiment;

FIG. 8 depicts a flowchart illustrating a process for multi-modal data encoding and decoding in accordance with an illustrative embodiment; and

FIG. 9 is an illustration of a block diagram of a data processing system in accordance with an illustrative embodiment.

### DETAILED DESCRIPTION

The illustrative embodiments described herein recognize and take into account different considerations. For example, the illustrative embodiments recognize and take into account that scientific and engineering data often multiple heterogeneous sources (multimodal) (e.g., images, 2D data, 1D data, scalar values, time-series data, etc.).

The illustrative embodiments also recognize and take into account that there is often a desire to integrate such multimodal data into a single decision-making tool. In parallel, there is a desire to integrate existing expert knowledge in the form of governing equations that are expected to describe one or more of the data sources. For example, in the domain of material process optimization, data may involve multiple sources of pre-process data (e.g., characterization of the feedstock, prior measurements on the precursor materials), in-process data (e.g., time-series measurements taken during the process, in-process diagnostics) and post-process data (e.g., measurements of the as-produced part including its structure, properties, and performance).

The illustrative embodiments provide physics-informed multimodal autoencoders (PIMA) that enable the fusion of different modes of data. The PIMA process assumes that all these data sources are stochastic and their values can be described as a multivariate gaussian distribution. The illustrative embodiments employ a “product of experts” (PoE) formulation to fuse the multiple sources (modes) of gaussian data into a single multivariate gaussian model, allowing for an efficient, disentangled, reduced-order latent space representation of the data. By disentangling data, the PIMA approach can identify clusters of like-behavior in the high-dimensional data, akin to principal component analysis, enabling a Gaussian mixture to identify shared features between the different modes. Sampling from clusters allows cross-modal generative modeling. The decoder can then predict virtual synthetic variations of each of the data modes. In parallel, the decoded data can optionally be fit to a provided expert (physics) model, which allows for traditional scientific modeling and simulation alongside purely data-driven empirical correlations.

Once the PIMA system has been exercised (trained) for a particular application, subsequent decoding can be performed even when limited data is available, enabling the trained PIMA system to provide expected results for all of the different data types. The process allows cross-modal inference using an instantiation from a single data mode from which a synthetic “cross-modal” representation of all data modes can be obtained. This decoder also allows physical model calibrations to be extracted from indirect (cross-modal) data sources, e.g., a calibrated stress-strain constitutive model can be determined from just a photograph of a structure.

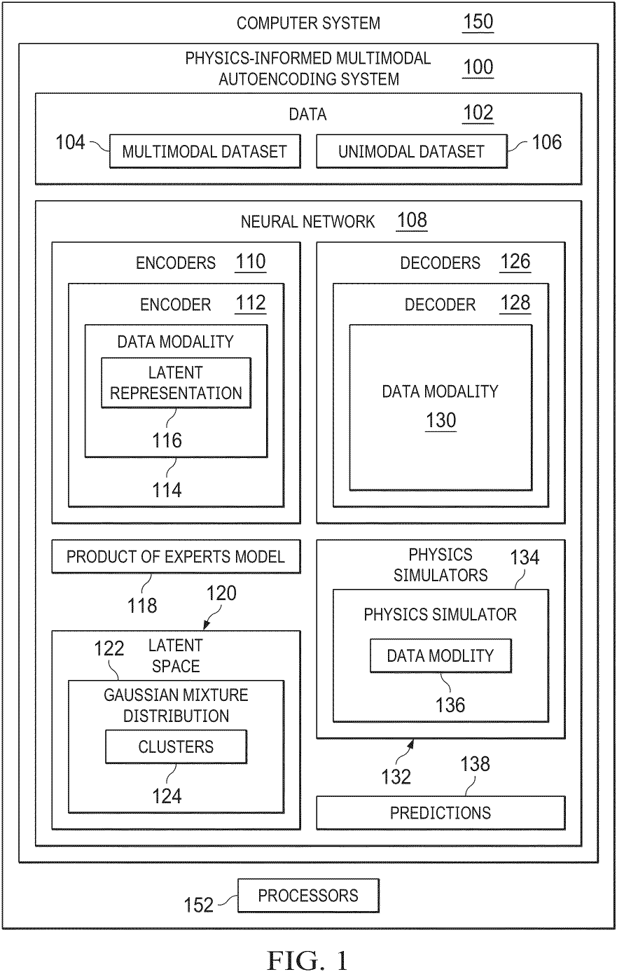

FIG. 1 depicts a physics-informed multimodal autoencoding (PIMA) system in accordance with an illustrative embodiment. PIMA system 100 comprises neural network 108 that is configured to encode and decode (reconstruct) data 102 to learn how to make predictions 136 about a specific physical phenomenon/process.

Neural network 108 comprises a number of encoders 110 configured to encode a multimodal dataset 104. Each encoder 114 is specific to a given data modality 114 within the multimodal dataset 104 and encodes that modality into a latent representation 116.

Neural network 108 uses a Product of Experts model 118 to combine the individual latent representations 116 into a single Gaussian mixture distribution 112 in a shared latent space 120. Gaussian mixture distribution 112 comprises a number of clusters 124 of sub-populations of the data. The clusters 124 represent all the modalities of data in the multimodal dataset 104 and encode cross-modal shared information which can be used for cross-modal inference.

Neural network 108 comprises a number of decoders 126 to reconstruct the multimodal dataset 104 from the Gaussian mixture distribution 122. There is a decoder 128 for each data modality 130. Neural network 108 may also comprise a number of physics simulators (models) 132 to reconstruct the multimodal dataset 104 from Gaussian mixture distribution 122. Each data modality 136 may be represented by a separate physics simulator 134 among the physics simulators 132.

After training, neural network 108 is then able to employ cross-modal inference to make predictions 138 about the physical phenomenon in question based on a unimodal dataset 106.

In the illustrative examples, the hardware may take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

The components for PIMA system 100 can be located in computer system 150, which is a physical hardware system and includes one or more data processing systems. When more than one data processing system is present in computer system 150 those data processing systems are in communication with each other using a communications medium. The communications medium can be a network. The data processing systems can be selected from at least one of a computer, a server computer, a tablet computer, or some other suitable data processing system.

For example, PIMA system 100 can run on one or more processors 152 in computer system 150. As used herein a processor is a hardware device and is comprised of hardware circuits such as those on an integrated circuit that respond and process instructions and program code that operate a computer. When processors 152 execute instructions for a process, one or more processors can be on the same computer or on different computers in computer system 150. In other words, the process can be distributed between processors 152 on the same or different computers in computer system 150. Further, one or more processors 152 can be of the same type or different type of processors 152. For example, one or more processors 152 can be selected from at least one of a single core processor, a dual-core processor, a multi-processor core, a general-purpose central processing unit (CPU), a graphics processing unit (GPU), a digital signal processor (DSP), or some other type of processor.

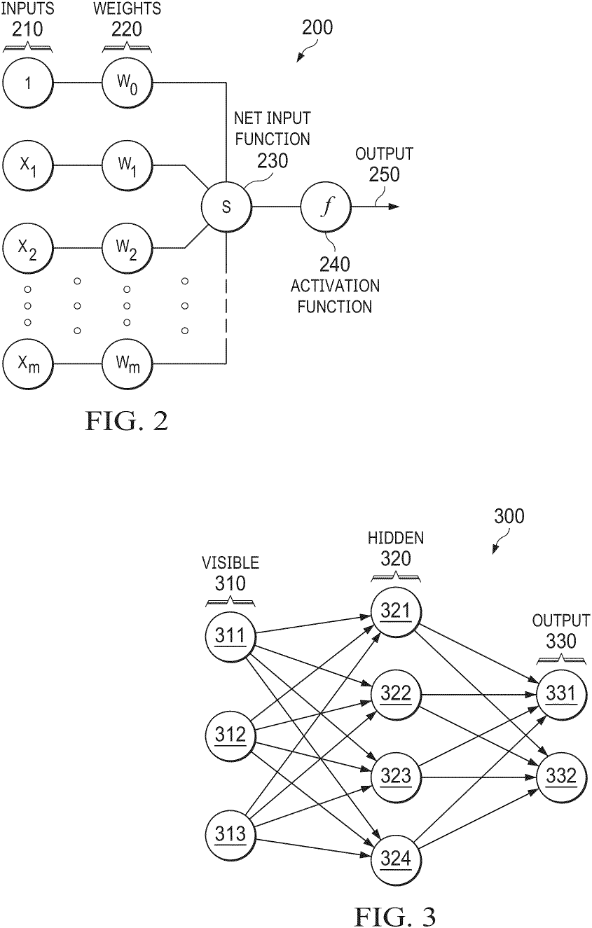

FIG. 2 depicts a diagram illustrating a node in a neural network in which illustrative embodiments can be implemented. Node 200 combines multiple inputs 210 from other nodes. Each input 210 is multiplied by a respective weight 220 that either amplifies or dampens that input, thereby assigning significance to each input for the task the algorithm is trying to learn. The weighted inputs are collected by a net input function 230 and then passed through an activation function 240 to determine the output 250. The connections between nodes are called edges. The respective weights of nodes and edges might change as learning proceeds, increasing or decreasing the weight of the respective signals at an edge. A node might only send a signal if the aggregate input signal exceeds a predefined threshold. Pairing adjustable weights with input features is how significance is assigned to those features with regard to how the network classifies and clusters input data.

Neural networks are often aggregated into layers, with different layers performing different kinds of transformations on their respective inputs. A node layer is a row of nodes that turn on or off as input is fed through the network. Signals travel from the first (input) layer to the last (output) layer, passing through any layers in between. Each layer’s output acts as the next layer’s input.

FIG. 3 depicts a diagram illustrating a neural network in which illustrative embodiments can be implemented. As shown in FIG. 3, the nodes in the neural network 300 are divided into a layer of visible nodes 310, a layer of hidden nodes 320, and a layer of output nodes 330. The nodes in these layers might comprise nodes such as node 300 in FIG. 3. The visible nodes 310 are those that receive information from the environment (i.e., a set of external training data). Each visible node in layer 310 takes a low-level feature from an item in the dataset and passes it to the hidden nodes in the next layer 320. When a node in the hidden layer 320 receives an input value x from a visible node in layer 310 it multiplies x by the weight assigned to that connection (edge) and adds it to a bias b. The result of these two operations is then fed into an activation function which produces the node’s output.

In fully connected feed-forward networks, each node in one layer is connected to every node in the next layer. For example, node 321 receives input from all of the visible nodes 311, 312, and 313 each x value from the separate nodes is multiplied by its respective weight, and all of the products are summed. The summed products are then added to the hidden layer bias, and the result is passed through the activation function to produce output to output nodes 331 and 332 in output layer 330. A similar process is repeated at hidden nodes 322, 323, and 324. In the case of a deeper neural network, the outputs of hidden layer 320 serve as inputs to the next hidden layer.

Artificial neural networks are configured to perform particular tasks by considering examples, generally without task-specific programming. The process of configuring an artificial neural network to perform a particular task may be referred to as training. An artificial neural network that is being trained to perform a particular task may be described as learning to perform the task in question.

Neural network layers can be stacked to create deep networks. After training one neural net, the activities of its hidden nodes can be used as inputs for a higher level, thereby allowing stacking of neural network layers. Such stacking makes it possible to efficiently train several layers of hidden nodes. Examples of stacked networks include deep belief networks (DBN), convolutional neural networks (CNN), recurrent neural networks (RNN), and spiking neural networks (SNN).

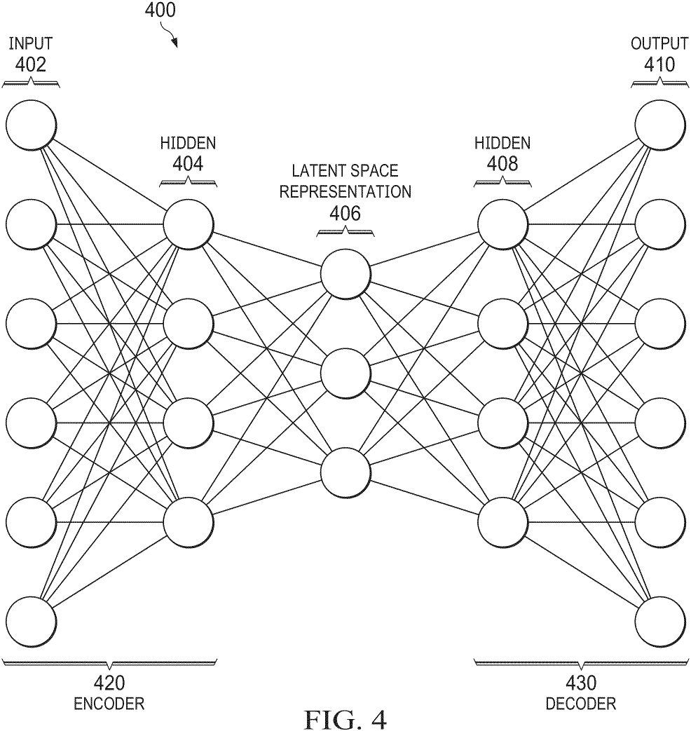

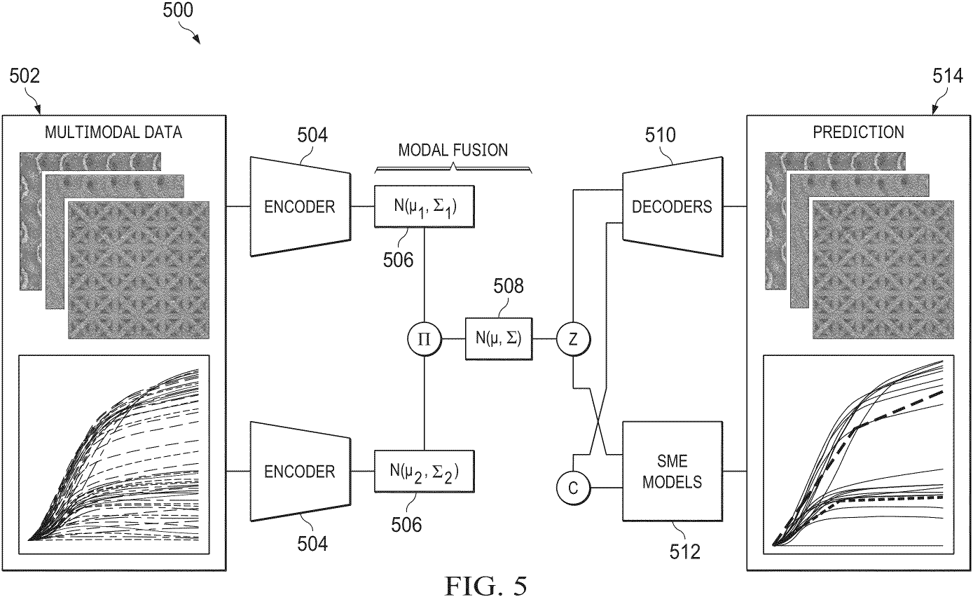

FIG. 4 depicts a sparse autoencoder neural network in which the illustrative embodiments can be implemented. As shown in FIG. 4, the nodes in autoencoder 400 are divided into several layers. An autoencoder is neural network that uses unsupervised learning to copy its input to its output. In the present example, autoencoder 400 comprises input layer 402 and output layer 410, which are visible layer. Located between input layer 402 and output layer 410 are hidden layers 404 and 408. In the center of autoencoder 400 is latent space representation 406.

Hidden layer 404 describes the latent space representation 406 used to represent the input data from input layer 402. Hidden layer 408 describes latent space representation 406 to represent output data for output layer 410. Input layer 402 and hidden layer 404 comprise encoder 420 that maps input data to latent space representation 406. Output layer 410 and hidden layer 408 comprise decoder 430 that maps latent space representation 406 to a reconstruction of the original input. Autoencoder 400 compresses data from the input layer 402 into a short code (latent space representation) by ignoring noise when reconstructing the inputs.

Autoencoder neural networks such as autoencoder 400 are particularly well suited to image recognition and reconstruction. The illustrative embodiments might employ image data as part of a multimodal dataset related to a physical phenomenon or process. For example, material stress/strain might be recorded via visual images of a physical object under load in conjunction with physical measurements of stress and strain within the object, allowing cross-modal comparison.

There are three main categories of machine learning: supervised, unsupervised, and reinforcement learning. Supervised machine learning comprises providing the machine with training data and the correct output value of the data. During supervised learning the values for the output are provided along with the training data (labeled dataset) for the model building process. The algorithm, through trial and error, deciphers the patterns that exist between the input training data and the known output values to create a model that can reproduce the same underlying rules with new data. Examples of supervised learning algorithms include regression analysis, decision trees, k-nearest neighbors, neural networks, and support vector machines.

If unsupervised learning is used, not all of the variables and data patterns are labeled, forcing the machine to discover hidden patterns and create labels on its own through the use of unsupervised learning algorithms. Unsupervised learning has the advantage of discovering patterns in the data with no need for labeled datasets. Examples of algorithms used in unsupervised machine learning include k-means clustering, association analysis, and descending clustering.

The illustrative embodiments provide a variational inference framework for synthesizing multimodal scientific data for cross-modal inference. If one can reliably perform generative modeling of a high-fidelity but slow measurement from a low-fidelity but fast fingerprint, high-throughput experimentation and material characterization are possible. Such applications however require an unsupervised learning approach, since costly human-in-the-loop data labelling precludes high-throughput testing.

Cross-modal inference corresponds to training an autoencoder jointly across modalities of data in a manner that supports generative sampling of individual modalities. The illustrative embodiments achieve this goal in a variational inference setting by: encoding data into unimodal embeddings and applying a Product of Experts model to fuse data into a multimodal posterior; adopting a Gaussian mixture prior to determine latent clusters shared across modalities of data; and decoding with physics-informed models/simulators to impose inductive biases. For scientific settings, the expert physics models/simulators provide a new means of fusing experimental data with traditional scientific models. Rather than considering generalized linear models commonly used in Mixture of Experts (MoE), the illustrative embodiments may incorporate parameterized physical models, surrogates, or simulators for the physical phenomenon/process under consideration. These elements are designed to yield an evidence lower bound (ELBO) loss with closed form expressions for requisite integrals and is amenable to a novel expectation maximization strategy to fit clusters and experts. In concert, this architecture produces fingerprints in the form of latent clusters spanning modalities of data with cross-modal estimators allowing inference of cluster membership for a single modality.

FIG. 5 depicts a physics-informed multimodal autoencoder (PIMA) in accordance with an illustrative embodiment. PIMA 500 may be an example implementation of physics-informed multimodal autoencoding system 100 shown in FIG. 1.

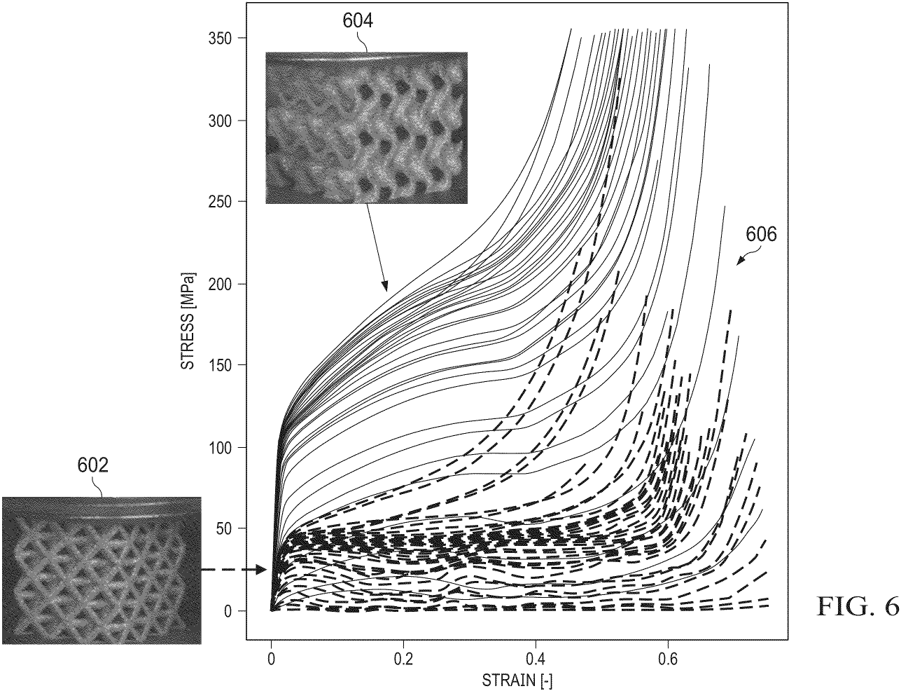

During training, multimodal data 502 is fed into and encoded by a number of encoders 504 into individual Gaussian distributions 506. The multimodal data 502 may comprise, for example, multiple images of an object subjected to different levels of mechanical loads as well as direct numerical measurements of stress and strain in that same object resulting from those loads. FIG. 6 depicts images and stress/strain curves comprising multimodal data related to a lattice structure subjected to external mechanical loading. Image 602 depicts the lattice microstructure prior to deformation. Image 604 depicts the lattice microstructure after deformation. Each image corresponds to different points along the stress/strain curves 606. It should be understood that only two images 602, 604 are shown for ease of illustration. In practice many more images would likely be used, corresponding to multiple points along the stress/strain curves 606.

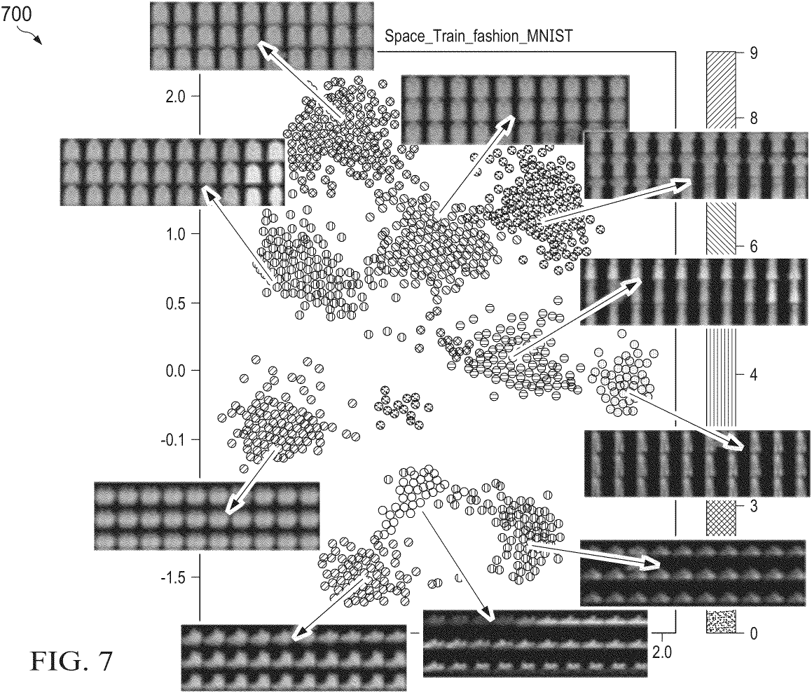

PIMA 500 may use a Product of Experts machine learning model to fuse complementary information into a shared multimodal Gaussian mixture distribution 508. The Gaussian mixture distribution 508 parameterizes a number of latent clusters of data that encode cross-modal shared information. FIG. 7 depicts a graph showing different clusters of data points corresponding to different levels of stress and strain and associated levels of deformation of the microstructure. The Gaussian mixture distribution 508 provides deep embedding for each modality of data. The clusters identify populations in data across modalities, which supports Baysian inference across the modalities. These clusters can be used to produce fingerprints from the weighted integration of disparate data sources, each with unique fidelity, sparsity, and spatiotemporal resolution. Disentanglement of clusters into structured latent space exposes relationships across modalities of data.

Sampling from the Gaussian mixture distribution 508 provides generative models using decoders 510 and expert physics models 512 that encode prior physics knowledge to makes prediction 514, which is a reconstruction of the original multimodal data 502. The physics models 512 provide physics-based inductive biases and move beyond purely data-driven linear techniques such as principal component analysis.

To facilitate cross-modal inference, unimodal embeddings are trained to reproduce the multimodal embedding. Cross-modal inference allows simulation of high-fidelity, low-throughput measurements from low-fidelity, high-throughput measurements. Using the example shown in FIG. 6, the strain lattice model allows two types of cross-modal inference between the high-throughput imaging of the lattice microstructure topology and the costly, low-throughput measurements of stress/strain response in the microstructure. After training with multimodal data, PIMA 500 can use unimodal high-throughput lattice imaging to determine a given stress/strain measurement.

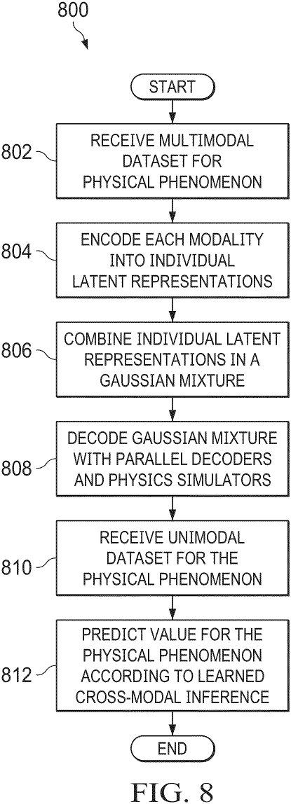

FIG. 8 depicts a flowchart illustrating a process for multi-modal data encoding and decoding in accordance with an illustrative embodiment. Process 800 can be implemented in hardware, software, or both. When implemented in software, the process can take the form of program code that is run by one or more processor units located in one or more hardware devices in one or more systems. Process 800 may be implemented in PIMA system 100 in FIG. 1.

Process 800 begins by receiving a multimodal dataset comprising number of different modalities of data related to a physical phenomenon common to the different modalities of data (step 802).

Process 800 then encodes each of the different modalities of data into an individual latent representation (step 804). The individual latent representations are combined into a single Gaussian mixture distribution in a shared latent space (step 806). The Gaussian mixture may be generated by a Product of Experts (PoE) machine learning model. The Gaussian mixture may comprise a combination of clusters of sub-populations of the data, wherein the clusters represent all the modalities of data. The clusters may encode cross-modal shared information.

A number of parallel decoders and physics simulators decode the Gaussian mixture (step 808). The decoders and physics simulators respectively reconstruct of the multimodal dataset. Each modality of data may be represented by a separate physics simulator among the physics simulators. Different data clusters may have different parameters for a same physics model.

The encoding and decoding in steps 804 and 806 may comprise unsupervised learning.

When a new unimodal dataset is received comprising a single modality of data related to the physical phenomenon (step 810), the trained model predicts a value of the physical phenomenon according to cross-modal inference learning from encoding and decoding of the multimodal dataset (step 812). Process 800 then ends.

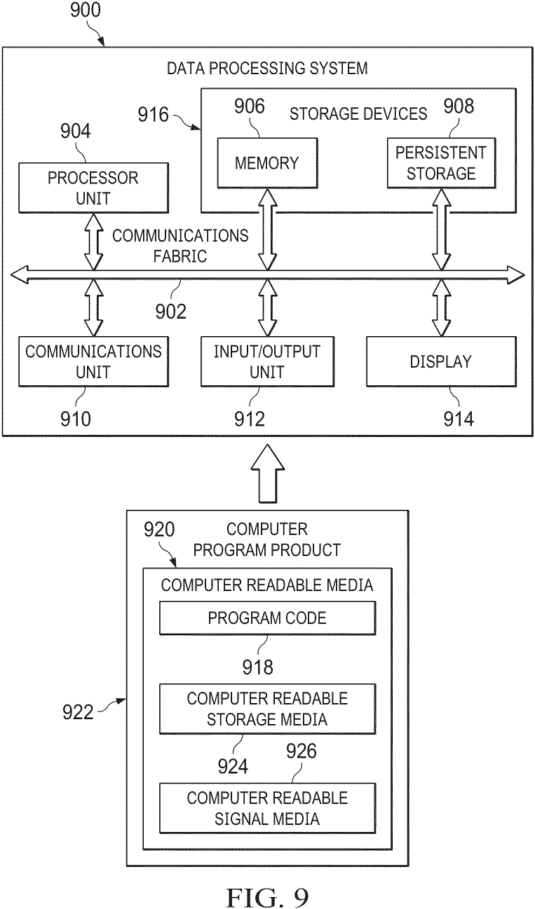

Turning to FIG. 9, an illustration of a block diagram of a data processing system is depicted in accordance with an illustrative embodiment. Data processing system 900 is an example of one possible implementation of a data processing system for performing functions of a multimodal encoding system in accordance with an illustrative embodiment. For example, data processing system 900 is an example of one possible implementation of a data processing system for implementing the PIMA system 100 in FIG. 1.

In this illustrative example, data processing system 900 includes communications fabric 902. Communications fabric 902 provides communications between processor unit 904, memory 906, persistent storage 908, communications unit 910, input/output (I/O) unit 912, and display 914. Memory 906, persistent storage 908, communications unit 910, input/output (I/O) unit 912, and display 914 are examples of resources accessible by processor unit 904 via communications fabric 902.

Processor unit 904 serves to run instructions for software that may be loaded into memory 906. Processor unit 904 may be a number of processors, a multi-processor core, or some other type of processor, depending on the particular implementation. Further, processor unit 904 may be implemented using a number of heterogeneous processor systems in which a main processor is present with secondary processors on a single chip. As another illustrative example, processor unit 904 may be a symmetric multi-processor system containing multiple processors of the same type.

Memory 906 and persistent storage 908 are examples of storage devices 916. A storage device is any piece of hardware that is capable of storing information, such as, for example, without limitation, data, program code in functional form, and other suitable information either on a temporary basis or a permanent basis. Storage devices 916 also may be referred to as computer readable storage devices in these examples. Memory 906, in these examples, may be, for example, a random access memory or any other suitable volatile or non-volatile storage device. Persistent storage 908 may take various forms, depending on the particular implementation.

For example, persistent storage 908 may contain one or more components or devices. For example, persistent storage 908 may be a hard drive, a flash memory, a rewritable optical disk, a rewritable magnetic tape, or some combination of the above. The media used by persistent storage 908 also may be removable. For example, a removable hard drive may be used for persistent storage 908.

Communications unit 910, in these examples, provides for communications with other data processing systems or devices. In these examples, communications unit 910 is a network interface card. Communications unit 910 may provide communications through the use of either or both physical and wireless communications links.

Input/output (I/O) unit 912 allows for input and output of data with other devices that may be connected to data processing system 900. For example, input/output (I/O) unit 912 may provide a connection for user input through a keyboard, a mouse, and/or some other suitable input device. Further, input/output (I/O) unit 912 may send output to a printer. Display 914 provides a mechanism to display information to a user.

Instructions for the operating system, applications, and/or programs may be located in storage devices 916, which are in communication with processor unit 904 through communications fabric 902. In these illustrative examples, the instructions are in a functional form on persistent storage 908. These instructions may be loaded into memory 906 for execution by processor unit 904. The processes of the different embodiments may be performed by processor unit 904 using computer-implemented instructions, which may be located in a memory, such as memory 906.

These instructions are referred to as program instructions, program code, computer usable program code, or computer readable program code that may be read and executed by a processor in processor unit 904. The program code in the different embodiments may be embodied on different physical or computer readable storage media, such as memory 906 or persistent storage 908.

Program code 918 is located in a functional form on computer readable media 920 that is selectively removable and may be loaded onto or transferred to data processing system 900 for execution by processor unit 904. Program code 918 and computer readable media 920 form computer program product 922 in these examples. In one example, computer readable media 920 may be computer readable storage media 924 or computer readable signal media 926.

Computer readable storage media 924 may include, for example, an optical or magnetic disk that is inserted or placed into a drive or other device that is part of persistent storage 908 for transfer onto a storage device, such as a hard drive, that is part of persistent storage 908. Computer readable storage media 924 also may take the form of a persistent storage, such as a hard drive, a thumb drive, or a flash memory, that is connected to data processing system 900. In some instances, computer readable storage media 924 may not be removable from data processing system 900.

In these examples, computer readable storage media 924 is a physical or tangible storage device used to store program code 918 rather than a medium that propagates or transmits program code 918. Computer readable storage media 924 is also referred to as a computer readable tangible storage device or a computer readable physical storage device. In other words, computer readable storage media 924 is a media that can be touched by a person.

Alternatively, program code 918 may be transferred to data processing system 900 using computer readable signal media 926. Computer readable signal media 926 may be, for example, a propagated data signal containing program code 918. For example, computer readable signal media 926 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 918 may be downloaded over a network to persistent storage 908 from another device or data processing system through computer readable signal media 926 for use within data processing system 900. For instance, program code stored in a computer readable storage medium in a server data processing system may be downloaded over a network from the server to data processing system 900. The data processing system providing program code 918 may be a server computer, a client computer, or some other device capable of storing and transmitting program code 918.

The different components illustrated for data processing system 900 are not meant to provide architectural limitations to the manner in which different embodiments may be implemented. The different illustrative embodiments may be implemented in a data processing system including components in addition to and/or in place of those illustrated for data processing system 900. Other components shown in FIG. 9 can be varied from the illustrative examples shown. The different embodiments may be implemented using any hardware device or system capable of running program code. As one example, data processing system 900 may include organic components integrated with inorganic components and/or may be comprised entirely of organic components excluding a human being. For example, a storage device may be comprised of an organic semiconductor.

In another illustrative example, processor unit 904 may take the form of a hardware unit that has circuits that are manufactured or configured for a particular use. This type of hardware may perform operations without needing program code to be loaded into a memory from a storage device to be configured to perform the operations.

For example, when processor unit 904 takes the form of a hardware unit, processor unit 904 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 918 may be omitted, because the processes for the different embodiments are implemented in a hardware unit.

In still another illustrative example, processor unit 904 may be implemented using a combination of processors found in computers and hardware units. Processor unit 904 may have a number of hardware units and a number of processors that are configured to run program code 918. With this depicted example, some of the processes may be implemented in the number of hardware units, while other processes may be implemented in the number of processors.

In another example, a bus system may be used to implement communications fabric 902 and may be comprised of one or more buses, such as a system bus or an input/output bus. Of course, the bus system may be implemented using any suitable type of architecture that provides for a transfer of data between different components or devices attached to the bus system.

Additionally, communications unit 910 may include a number of devices that transmit data, receive data, or both transmit and receive data. Communications unit 910 may be, for example, a modem or a network adapter, two network adapters, or some combination thereof. Further, a memory may be, for example, memory 906, or a cache, such as that found in an interface and memory controller hub that may be present in communications fabric 902.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the figures. For example, the functions of two blocks shown in succession may be executed substantially concurrently, or the functions of the blocks may sometimes be executed in the reverse order, depending upon the functionality involved.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A computer-implemented method of multi-modal data autoencoding, the method comprising:
using a number of processors to perform the steps of:
receiving a multimodal dataset comprising number of different modalities of data related to a physical phenomenon common to the different modalities of data;
encoding each of the different modalities of data into an individual latent representation;
combining the individual latent representations into a single Gaussian mixture distribution in a shared latent space;
decoding the Gaussian mixture with a number of parallel decoders and physics simulators, wherein the decoders and physics simulators respectively reconstruct the multimodal dataset;
receiving a unimodal dataset comprising a single modality of data related to the physical phenomenon; and
predicting a value of the physical phenomenon according to cross-modal inference learning from encoding and decoding of the multimodal dataset.

2. The method of claim 1, wherein the Gaussian mixture comprises a combination of clusters of sub-populations of the data, wherein the clusters represent all the modalities of data.

3. The method of claim 2, wherein the clusters encode cross-modal shared information.

4. The method of claim 2, wherein different clusters have different parameters for a same physics model.

5. The method of claim 1, wherein each modality of data is represented by a separate physics simulator among the physics simulators.

6. The method of claim 1, wherein the encoding and decoding comprise unsupervised learning.

7. The method of claim 1, wherein the Gaussian mixture is generated by a Product of Experts model.

8. A system for multi-modal data autoencoding, the system comprising:
a storage device configured to store program instructions; and
one or more processors operably connected to the storage device and configured to execute the program instructions to cause the system to:
receive a multimodal dataset comprising number of different modalities of data related to a physical phenomenon common to the different modalities of data;
encode each of the different modalities of data into an individual latent representation;
combine the individual latent representations into a single Gaussian mixture distribution in a shared latent space;
decode the Gaussian mixture with a number of parallel decoders and physics simulators, wherein the decoders and physics simulators respectively reconstruct the multimodal dataset;
receive a unimodal dataset comprising a single modality of data related to the physical phenomenon; and
predict a value of the physical phenomenon according to cross-modal inference learning from encoding and decoding of the multimodal dataset.

9. The system of claim 8, wherein the Gaussian mixture comprises a combination of clusters of sub-populations of the data, wherein the clusters represent all the modalities of data.

10. The system of claim 9, wherein the clusters encode cross-modal shared information.

11. The system of claim 9, wherein different clusters have different parameters for a same physics model.

12. The system of claim 8, wherein each modality of data is represented by a separate physics simulator among the physics simulators.

13. The system of claim 8, wherein the encoding and decoding comprise unsupervised learning.

14. The system of claim 8, wherein the Gaussian mixture is generated by a Product of Experts model.

15. A computer program product for multi-modal data autoencoding, the computer program product comprising:
a computer-readable storage medium having program instructions embodied thereon to perform the steps of:
receiving a multimodal dataset comprising number of different modalities of data related to a physical phenomenon common to the different modalities of data;
encoding each of the different modalities of data into an individual latent representation;
combining the individual latent representations into a single Gaussian mixture distribution in a shared latent space;
decoding the Gaussian mixture with a number of parallel decoders and physics simulators, wherein the decoders and physics simulators respectively reconstruct the multimodal dataset;
receiving a unimodal dataset comprising a single modality of data related to the physical phenomenon; and
predicting a value of the physical phenomenon according to cross-modal inference learning from encoding and decoding of the multimodal dataset.

16. The computer program product of claim 15, wherein the Gaussian mixture comprises a combination of clusters of sub-populations of the data, wherein the clusters represent all the modalities of data.

17. The computer program product of claim 16, wherein the clusters encode cross-modal shared information.

18. The computer program product of claim 16, wherein different clusters have different parameters for a same physics model.

19. The computer program product of claim 15, wherein each modality of data is represented by a separate physics simulator among the physics simulators.

20. The computer program product of claim 15, wherein the encoding and decoding comprise unsupervised learning.

21. The computer program product of claim 15, wherein the Gaussian mixture is generated by a Product of Experts model.
